(19) United States
(12) Patent Application Publication
(10) Pub. No.: US 2005/0025110 A1
(43) Pub. Date: Feb. 3, 2005

(54) Method and apparatus for calculation of path weights in a RAKE receiver

(76) Inventors: Burkhard Becker, Ismaning (DE); Jens Berkmann, Munchen (DE); Jurgen Niederholz, Kerken (DE); Michael Speth, Dusseldorf (DE); Manfred Zimmermann, Munchen (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 10/875,407

(22) Filed: Jun. 24, 2004

(30) Foreign Application Priority Data
Jun. 24, 2003 (DE) DE 103 28 340.4

(51) Int. Cl. H04B 1/713

(52) U.S. Cl. 370/342; 370/332

(57) ABSTRACT

A method for calculation of path weights for the equalization of a data signal that is transmitted via a data channel whose power is regulated in a RAKE receiver is disclosed. In the method, at least one uncorrected path weight is calculated for the data signal that is transmitted via the data channel, using channel estimation results that have been obtained on the basis of a common pilot channel. The uncorrected path weight is corrected by multiplying it by a correction factor that contains a ratio of a data-channel-specific gain estimation to a pilot-channel-based gain estimation.

### REFERENCE TO RELATED APPLICATIONS

This application claims the benefit of the priority date of German application DE 103 28 340.4, filed on Jun. 24, 2003, the contents of which are herein incorporated by reference in their entirety.

This application is related to U.S. application Ser. No.______ (Attorney Docket No. LLP130US), filed on Jun. 24, 2004, entitled “METHOD AND APPARATUS FOR CALCULATION OF CORRECTION FACTORS FOR PATH WEIGHTS IN A RAKE RECEIVER”, and U.S. application Ser. No. ______ (Attorney Docket No. LLP131US), filed on Jun. 24, 2004, entitled “METHOD AND APPARATUS FOR WEIGHTING CHANNEL COEFFICIENTS IN A RAKE RECEIVER,” both of which are hereby incorporated by reference in their entirety.

### FIELD OF THE INVENTION

The invention relates to a method and an apparatus for calculation of path weights for the equalization of a data signal, which is transmitted via a data channel whose power is regulated, in a RAKE receiver.

### BACKGROUND OF THE INVENTION

One typical receiver concept that is used in CDMA (Code Division Multiple Access) transmission systems is the so-called RAKE receiver. The method of operation of the RAKE receiver is to add signal contributions that reach the receiver via different transmission paths in weighted and synchronized form. For this purpose, the RAKE receiver has a number of “fingers” whose outputs are connected to a combiner. During operation, the fingers are associated with the individual propagation paths and carry out the path-specific demodulation (delay, despreading, symbol formation, multiplication by the path weight). The combiner superimposes those signal components that are transmitted via different propagation paths and are associated with the same signal.

The path weights may be calculated in various ways depending on the options that the transmission system provides and the technical complexity of the receiver.

One low-complexity option is binary weighting, in which only the propagation path with the best quality is used. One typical quality measure is the signal-to-noise power plus interference ratio (SINR) of the received data symbols. In this procedure, only a single RAKE finger is required for each data channel to be equalized.

One further frequently used option is to provide for exclusive consideration of the path-specific signal phases with the magnitudes of all the path contributions being given equal weighting.

The optimum weighting of the individual paths in the sense of the maximum SINR for the overall signal produced by path combination is achieved by the so-called Maximum Ratio Combining (MRC) process. In the case of MRC, the individual path-specific signal contributions are weighted on the basis of their path-specific SINR, and are then added up.

Various aspects must be taken into account for calculation of the path weights: if the aim is to equalize a data channel that contains pilot symbols (that is to say symbols that are known in the receiver), these symbols may be used for channel estimation, that is to say for calculation of the path weights. A situation such as this occurs in the case of the UMTS (Universal Mobile Telecommunications System) Standard for example for the dedicated (Subscriber Specific) data channel DCH (Dedicated Channel). However, this procedure has the disadvantage that the number of pilot symbols in one time slot is frequently not sufficient for accurate channel estimation.

Another possibility is to carry out the channel estimation process on the basis of a common pilot channel (that is to say a pilot channel that is intended for all the subscribers), that is provided by the base station. One channel that is suitable for this purpose in the UMTS Standard is the P-CPICH (Primary Common Pilot Channel). Calculation of channel weights on the basis of the P-CPICH has good statistics. It is generally therefore preferred for channel estimation based on dedicated pilot symbols (for example for the DCH). Data channels that contain no dedicated pilot symbols—for UMTS this applies, for example, to the common downlink data channel DSCH (Downlink Shared Channel)—necessarily have to be dedmodulated by calculation of channel weights on the basis of a common pilot channel.

When using a common pilot channel for calculation of the path weights for a data channel to be demodulated, the channel characteristic of the physical transmission channel is admittedly measured more or less appropriately, but this results in the problem that transmitter power regulation of the data signal path is ignored. This leads to a loss of performance in the further processing of the combined signal, particularly during its decoding.

### SUMMARY OF THE INVENTION

The invention is based on the object of specifying a method that provides for accurate calculation of path weights for the equalization of a data channel by means of a RAKE receiver. A particular aim is to take account of the influence of power regulation in the data signal to be equalized when calculating the path weights. A further aim of the invention is to provide an apparatus having the stated characteristics.

Accordingly, in the case of the method according to the invention for calculation of path weights for the equalization of a data signal which is transmitted via a data channel whose power is regulated, at least one uncorrected path weight is calculated in a first step, using channel estimation results obtained on the basis of a common pilot channel. In a second step, this uncorrected path weight is corrected, to be precise by multiplying it by a correction factor that contains the ratio of a data-channel-specific gain estimation to a pilot-channel-based gain estimation.

The method according to the invention thus combines the advantage of pilot-channel-based channel estimation (high accuracy resulting from good statistics) with consideration of the influence of the power regulation in the data channel using the correction factor.

Power regulation is normally carried out on a time slot basis, while coding of the data to be transmitted (for example CRC: Cyclic Redundancy Code) extends over a considerably longer time period—specifically two or more frame intervals (for example, in UMTS, one frame covers 15 time slots). The invention makes it possible to produce data symbols at the output of the RAKE receiver that are correctly weighted over the length of a code word, even when the code word has been transmitted for time slots with different power levels in each time slot at the transmitter end. In consequence, more powerful decoding algorithms, such as logarithmic MAP (Maximum A Posteriori) turbo decoding, can be used in the signal path downstream from the RAKE receiver. Finally, the items that have been mentioned result in improved performance of the entire receiver (RAKE receiver with downstream data processing), and this is evident in an improvement in the bit error rates and block error rates.

According to a first advantageous exemplary embodiment of the method according to the invention, the data channel is the common downlink channel DSCH in the UMTS Standard. One specific problem relating to weight estimation in the case of the DSCH results from the fact that, in contrast to the DCH for example, it does not contain any pilot fields (sections consisting of pilot symbols), but has only data symbols. Thus, it is in principle impossible to evaluate pilot symbols in the DSCH channel (with such evaluation intrinsically also taking into account power regulation). A further specific problem with the DSCH is that the UMTS Standard does not standardize the power regulation mechanism in a mandatory manner. Since, on the basis of the method according to the invention, no dedicated pilot symbols are required to estimate the path weights for the DSCH, the method according to the invention can also be used in particular for calculation of DSCH path weights that have been corrected for power regulation.

A second advantageous exemplary embodiment of the method according to the invention is characterized in that the data channel is a dedicated downlink channel DCH based on the UMTS Standard. The UMTS Standard explicitly specifies the power regulation in the DCH channel, and this is controlled via a TPC (Transmission Power Control) field in the DCH channel. The method according to the invention has the advantageous feature that the known inaccurate weight estimation process, based on the dedicated pilot symbols in the DCH channel, need not be used in order to correctly take account of the influence of the power regulation.

In principle, the method according to the invention can be used for low-complexity equalization that takes account of only one propagation path for each signal. However, two or more uncorrected path weights are preferably calculated for two or more propagation paths of the data signal in one specific mobile radio cell, and all of the uncorrected path weights for this mobile radio cell are multiplied by the same correction factor. This takes account of the influence of the power regulation in the combined signal (that is to say the signal that is formed by superimposition of the path-specific signal components).

One particularly advantageous refinement of the method according to the invention comprises the correction factor being

$$f = \frac{{\hat{W}}_{Data Channel}}{{\hat{W}}_{C}} \frac{1}{{\hat{σ}}_{D}^{2}} ,$$

where ŵ_{Data Channel} is an estimated value for the transmitter gain for the data channel whose power is regulated, Ŵ_{C} is an estimated value for the transmitter gain for the common pilot channel and \hat{σ}_{D} is an estimated value for the noise variance on the data channel. The additional inclusion of the noise variance \hat{σ}_{D} in the correction factor ensures “real” MRC path combination.

### BRIEF DESCRIPTION OF THE DRAWINGS

The invention will be explained in more detail in the following text using two exemplary embodiments and with reference to the drawings, in which:

FIG. 1 shows the data structure of the DPCH (Downlink Dedicated Physical Channel);

FIG. 2 shows a schematic illustration in order to explain the influence of a transmitter power regulation and of the transmission channel on the signal vectors x_{c}(k) and x_{DSCH}(k) based on a first exemplary embodiment of the invention;

FIG. 3 shows a schematic illustration in order to explain the influence of transmitter power regulation and of the transmission channel on the signal vectors x_{c}(k) and x_{D}(k) based on a second exemplary embodiment of the invention; and

FIG. 4 shows a schematic illustration of a circuit for carrying out signal and noise power estimation for calculation of the correction factor.

### DETAILED DESCRIPTION OF THE INVENTION

The method according to the invention will be explained in the following text with reference to two examples, to be precise calculation of path weights for the DSCH (example 1) and calculation of path weights for the DCH (example 2). Both examples are based on a UMTS-compliant RAKE receiver. The method according to the invention may, however, also be used for calculation of path weights in mobile radio systems of a general third-generation or higher generation type.

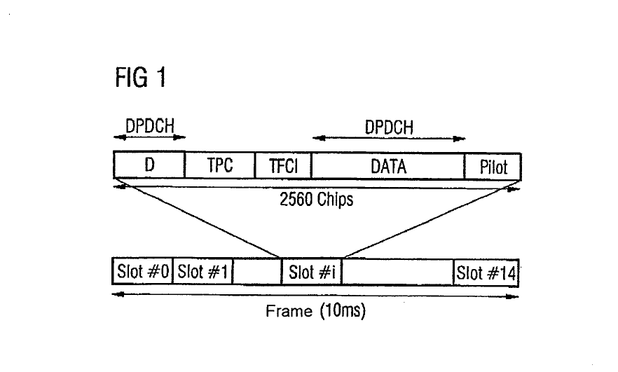

In order to assist understanding of the second exemplary embodiment, FIG. 1 shows the frame and a time slot structure for the DPCH channel, via which the DCH transport channel is transmitted in the downlink. The frame duration is 10 milliseconds, and comprises 15 time slots. The fields D, TPC, TFCI, DATA, Pilot are transmitted in each time slot. The fields D and DATA contain payload data in the form of spread-coded data symbols. These two data fields form the DPDCH (Dedicated Physical Data Channel) channel. The TPC field is used, as already mentioned, for power regulation. The TFCI (Transport Format Combination Indicator) field is used to signal to the receiver the transport formats of the transport channels on which the transmitted frame is based. The Pilot field contains between 4 and 32 (dedicated) pilot chips. In total, one time slot comprises 2560 chips. The chip time duration (which is specified as fixed in the UMTS Standard) is thus 0.26 μs.

Let us consider multipath propagation in the downlink (downlink path from the base station to the mobile station) via M propagation paths. It is assumed that synchronized reception including the processing steps of despreading, descrambling and integration over one symbol duration have already been carried out. The steps of despreading and descrambling are carried out by multiplication operations via code sequences of normalized energy at the chip level and—in accordance with the normal method of operation of a RAKE receiver—are carried out for the associated propagation path in each RAKE finger. The subsequent integration over the symbol time duration is frequently also referred to as integrate and dump and adds up the synchronized despread and descrambled chips in one symbol. The number of chips to be added up is predetermined in a known manner by the spreading factor SF of the respective channel whose signal component is demodulated in that finger. The data is produced at the symbol clock rate in the signal path downstream from the integrator. The symbol sequences received in this manner can be represented as vectors x_{c}(k) for the P-CPICH channel, x_{DSCH}(k) for the DSCH channel and x_{D}(k) for the DCH channel, with each vector component being associated with a sequence which is being transmitted via one of the m=1, . . . , M propagation paths:

$$\begin{matrix}{x}_{C} ( k ) = [ \begin{matrix}{x}_{C ; 1} ( k ) \\ ⋮ \\ {x}_{C ; m} ( k ) \\ ⋮ \\ {x}_{C ; M} ( k )\end{matrix} ] , & ( 1 ) \\ {x}_{DSCH} ( k ) = [ \begin{matrix}{x}_{DSCH ; 1} ( k ) \\ ⋮ \\ {x}_{DSCH ; m} ( k ) \\ ⋮ \\ {x}_{DSCH ; M} ( k )\end{matrix} ] , & ( 2 a ) \\ {x}_{D} ( k ) = [ \begin{matrix}{x}_{D ; 1} ( k ) \\ ⋮ \\ {x}_{D ; m} ( k ) \\ ⋮ \\ {x}_{D ; M} ( k )\end{matrix} ] & ( 2 b )\end{matrix}$$

The individual vector components of the P-CPICH channel are given by:
x_{C;m}(k)=W_{C}a_{C;m}(k)p_{C}(k)+n_{C;m}(k), (3)
x_{DSCH;m}(k)=W_{DSCH}a_{DSCH;m}(k)s_{DSCH}(k)+n_{DSCH;m}(k, (4a)
x_{D;m}(k)=wᵣa_{D;m}(k)sₓ(k)+n_{D;m}(k), (4b)
with the channel-specific, real gain levels
W_{C}=W_{C,offset}W_{C,SF}, (5)
W_{DSCH}=W_{DSCH,offset}W_{PC}W_{DSCH,SF}, (6a)

$${W}_{x} = {W}_{x , offset} {W}_{PC} {W}_{D , SF} where {W}_{x , offset} = \{ \begin{matrix}{W}_{D , offset} \\ {W}_{TPC , offset} \\ {W}_{TFCI , offset} \\ {W}_{DATA , offset}\end{matrix} , \qquad ( 6 b )$$

The path-specific complex channel coefficients a_{c;m}(k), a_{DSCH;m}(k), a_{D;m}(k), the noise contributions n_{c;m}(k), n_{DSCH;m}(k), n_{D;m}(k), the energy-normalized pilot sequence p_{c}(k), the energy normalized DSCH data symbol sequence S_{DSCH}(k) as well as the energy-normalized data symbol, TPC, TFCI and data symbol sequences sₓ(k)=p_{D}(k), s_{TPC}(k), s_{TFCI}(k), s_{DATA}(k). The weights W_{Coffset}, W_{DSCH,offset}, W_{X,offset} take account of the transmitter gain in the P-CPICH channel, in the DSCH channel and the fields X in the DPCH channel, the weights W_{C,SF}, W_{DSCH,SF}, W_{D,SF} take account of the respective spreading factor and the weight W_{PC} takes account of the power regulation in the DSCH channel (example 1) or in the DCH channel (example 2). W_{C} and Wₓ are constant over one UMTS slot. In this context, no assumption is made with respect to the W_{DSCH} since the UMTS Standard contains no details relating to the transmitter power regulation—and thus relating to W_{pc}.

The DSCH channel (example 1) is considered, which comprises only data symbols, then the SINR ρ_{DSCH;m} for the m-th path is given by:

$$\begin{matrix}{ρ}_{DSCH ; m} = \frac{{S}_{DSCH ; m}}{{N}_{DSCH ; m}} = \frac{{W}_{DSCH}^{2} {\vert {a}_{DSCH ; m} \vert}^{2}}{{σ}_{DSCH ; m}^{2}} , where & ( 7 a ) \\ {W}_{DSCH} = {W}_{DSCH , offset} {W}_{PC} {W}_{DSCH , SF} . & ( 8 a )\end{matrix}$$

In this case S_{DSCH;m}=W_{DSCH}²|a_{DSCH;m}|² denotes the data signal power in the m-th path and N_{DSCH;m}=σ_{DSCH;m}² denotes the interference power in the m-th path.

If the DATA data field of the DCH channel is considered, then the SINR ρ_{DATA;m} for the m-th path is given by:

$$\begin{matrix}{ρ}_{DATA ; m} = \frac{{S}_{DATA ; m}}{{N}_{D ; m}} = \frac{{W}_{DATA}^{2} {\vert {a}_{D ; m} \vert}^{2}}{{σ}_{D ; m}^{2}} , where & ( 7 b ) \\ {W}_{DATA} = {W}_{DATA , offset} {W}_{PC} {W}_{D , SF} . & ( 8 b )\end{matrix}$$

In this case, S_{DATA;m}=W_{DATA}²|a_{D;m}|² denotes the data signal power in the m-th path, and N_{D;m}=σ²_{D;m} denotes the interference power in the m-th path.

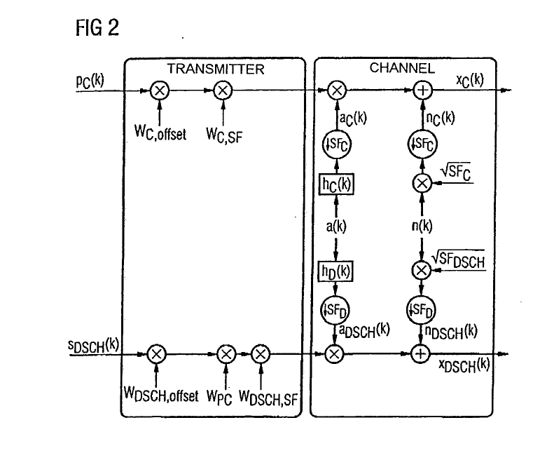

With regard to example 1, FIG. 2 shows the composition of the complex vectors x_{c}(k) and x_{DSCH}(k). The production process in the transmitter comprises weighting of the respective symbol sequences in accordance with equations (3) and (5) and in accordance with equations (4a) and (8a), respectively. The illustration is based on the assumption that the chip sequences p_{c}(k) and S_{DSCH}(k) are normalized with respect to the chip energy, that is to say the energy in each chip is E_{chip}=1. The power setting values W_{c,offset} and W_{DSCH,offset} may differ, but in the following text are regarded as being constant over time. The factors W_{C,SF} and W_{D,SF} which define the spreading gain are governed by the spreading factor SF_{c} in the P-CPICH channel and, respectively, by the spreading factor SFₙ in the DSCH channel, that is to say W_{C,SF}=SF_{C} and W_{DSCH,SF}=SF_{D}. As already mentioned, the factor W_{PC} takes account of the power regulation mechanism, which is configured only for the DSCH channel.

It should be mentioned that no information is available a priori about the relationship between the power setting values W_{C,offset} and W_{DSCH,offset}.

The influence of the channel can be indicated by a channel impulse response a(k) and a noise contribution n(k). Both variables characterize the channel behaviour on a chip time basis, indexed by the index k. The respective spread factors SF_{C} and SF_{D} are taken into account by filtering each vector component (that is to say each propagation path) with the channel impulse response a(k), and undersampling it as a function of the respective spreading factor. The corresponding filters h_{c}(k) and h_{D}(k), respectively, are in the form:

$${h}_{C} ( k ) = \{ \begin{matrix}1 / {SF}_{C} & k ∈ [ 0 , {SF}_{C} - 1 ] \\ 0 & else\end{matrix} , \\ {h}_{D} ( k ) = \{ \begin{matrix}1 / {SF}_{D} & k ∈ [ 0 ; {SF}_{D} - 1 ] \\ 0 & else\end{matrix} .$$

The noise vectors n_{c}(k) and n_{DSCH}(k), respectively, are obtained from the channel noise n(k) by multiplication by SF_{C}^{1/2} or SF_{D}^{1/2}, respectively, and are likewise undersampled by the corresponding spreading factors. The resultant vectors for the noise contributions n_{c}(k) and n_{DSCH}(k), respectively, are additively included in the vectors x_{c}(k) and, x_{DSCH}(k) respectively.

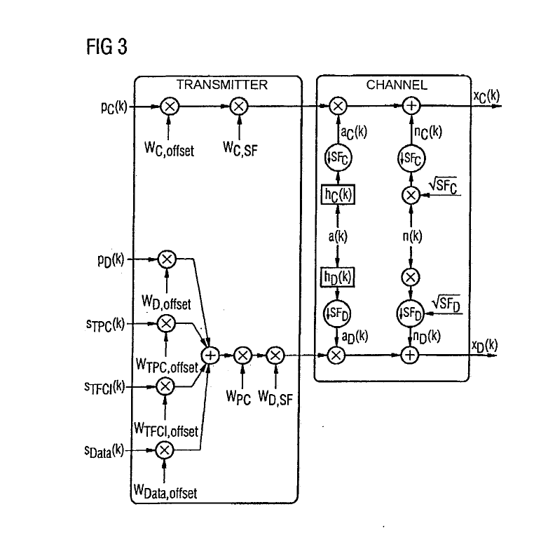

In an analogous illustration, FIG. 3 shows the production of the vectors x_{c}(k) and x_{D}(k) relating to example 2, that is to say the transmission of the DCH transport channel via the physical channel DPCH. The input sequences p_{D}(k), S_{TPC}(k), S_{TFCI}(k) and s_{Data}(k) are all normalized with respect to the chip energy E_{Chip}=1. Different gain settings W_{x,offset}, X=D, TPC, TFCI, Data may be used for the individual fields, but their relationships to one another are known and may in this case be regarded as being constant over time. In the same way as in example 1, the power regulation of the transmitter on a time slot basis is taken into account by the weight W_{PC}. The influence of the channel is analogous to that in example 1 (FIG. 2).

The following text considers the calculation of path weights at the receiver end.

Example 1: in the case of a RAKE receiver, the decision variable z_{DSCH}(k) for the DSCH data symbols (that is to say the output variable from the combiner) is governed by the weighted sum over all the path contributions:

$$\begin{matrix}{z}_{DSCH} ( k ) = {\sum }_{m = 1}^{M} {w}_{DSCH ; m}^{*} ( k ) {x}_{DSCH ; m} ( k ) , where & ( 9 a ) \\ {x}_{DSCH ; m} ( k ) = \underbrace{{W}_{DSCH} {a}_{DSCH ; m} ( k ) {s}_{DSCH} ( k )}_{Signal payload component} + \underbrace{{n}_{DSCH ; m} ( k )}_{{Interference}_{component}} . & ( 10 a )\end{matrix}$$

The weights w_{DSCH;m}(k) used in the receiver thus typically include an estimate of the resultant channel coefficients W_{DSCH}a_{DSCH;m}(k). If “real” MRC is carried out, then the weights are given by:

$${w}_{DSCH ; m} ( k ) = \frac{{W}_{DSCH} {a}_{DSCH ; m} ( k )}{{σ}_{DSCH ; m}^{2}} , \qquad ( 11 a )$$

so that, taking into account equations (9a) and (10a), the following expression is obtained as the resultant SINR for z_{DSCH}(k)

$${ρ}_{DSCH} = {\sum }_{m = 1}^{M} \frac{{S}_{DSCH ; m}}{{N}_{DSCH ; m}} = {\sum }_{m = 1}^{M} \frac{{W}_{DSCH}^{2} {\vert {a}_{DSCH ; m} \vert}^{2}}{{σ}_{DSCH ; m}^{2}} \qquad ( 12 a )$$

The calculation according to the invention of the path-specific weight factors w_{DSCH;m}(k) is carried out in two steps. The first step corresponds to the fundamental principle of the P-CPICH channel, which is known from the prior art, for estimation of the path weights.

Step 1: step 1 can be carried out in two different ways:
1.1 Only the propagation path m′ with the greatest SINR ρ_{DSCH;m′} is used for the calculation of the decision variable z_{DSCH}(k), and all the other weights are set to zero. The channel coefficient estimate w_{DSCH;m′}(k)=W_{c}a_{c;m′}(k)+ε_{c;m′}(k) based on the P-CPICH channel is used as the estimate of the resultant channel coefficient w_{DSCH}a_{DSCH;m}(k).
1.2 All of the propagation paths are taken into account in the summation process. As in case 1.1, the channel coefficient estimates w_{DSCH;m}(k)=W_{c}a_{c;m}(k)+ε_{c;m}(k) based on the P-CPICH channel are used as the estimate of the resultant channel coefficients W_{DSCH}a_{DSCH;m}(k), m =1, . . . , M.

The situation for example 2 is as follows:

if only the data component (fields D, DATA) in the DPCH channel is considered, then the decision variable z_{DATA}(k) for a RAKE receiver is governed by the weighted sum of all the path contributions:

$$\begin{matrix}{z}_{DATA} ( k ) = {\sum }_{m = 1}^{M} {w}_{DATA ; m}^{*} ( k ) {x}_{DATA ; m} ( k ) , where & ( 9 b ) \\ {x}_{DATA ; m} ( k ) = \underbrace{{W}_{DATA} {a}_{D ; m} ( k ) {s}_{DATA} ( k )}_{Signal payload component} + \underbrace{{n}_{D ; m} ( k )}_{{Interference}_{component}} . & ( 10 b )\end{matrix}$$

The weights w_{DATA;m}(k) which are used in this case typically include an estimate of the resultant channel coefficient w_{DATA}a_{D;m}(k). If “real” MRC is carried out, then the weights are given by:

$${w}_{DATA ; m} ( k ) = \frac{{W}_{DATA} {a}_{D ; m} ( k )}{{σ}_{D ; m}^{2}} , \qquad ( 11 b )$$

so that, taking account of equations (9b) and (10b), the following expression is obtained as the resultant SINR for z_{DATA}(k)

$${ρ}_{DATA} = {\sum }_{m = 1}^{M} \frac{{S}_{DATA ; m}}{{N}_{D ; m}} = {\sum }_{m = 1}^{M} \frac{{W}_{DATA}^{2} {\vert {a}_{D ; m} \vert}^{2}}{{σ}_{D ; m}^{2}} \qquad ( 12 b )$$

The calculation according to the invention of the path-specific weight factors w_{DATA;m}(k) is carried out in two steps. Analogously to example 1, the following two options are available for the first step:
1.1 Only the propagation path m′ with the greatest SINR ρ_{DATA;m′} is used for the calculation of the decision variable z_{DATA}(k), and all the other weights are set to zero. The channel coefficient estimate w_{DATA;m′}(k)=W_{c}a_{c;m′}(k)+ε_{c;m′}(k) based on the P-CPICH channel is used as the estimate of the resultant channel coefficient W_{DATA}a_{D;m′}(k).
1.2 All of the propagation paths are taken into account in the summation process. As in case 1.1, the channel coefficient estimates w_{DATA;m}(k)=W_{c}a_{c;m}(k)+ε_{c;m}(k) based on the P-CPICH channel are used as the estimate of the resultant channel coefficients W_{DATA}a_{D;m}(k), m=1, . . . , M.

Thus, according to the invention, no estimate of the DCH channel based on the dedicated pilot symbols and dependent on the power regulation is carried out.

The terms ε_{C;m′}(k), ε_{C;m}(k) in the above equation represent additive estimation errors, which produce additional interference influences and thus adversely affect the achievable SINR.

It is evident that, even if the estimation error were zero, the P-CPICH-based strategy used in step 1 for estimation of path weights has a fundamental disadvantage: based on equations (11a) and (11b), respectively, then it would be necessary for w_{DSCH;m}(k)=W_{DSCH}a_{DSCH;m}(k) (example 1) and w_{DATA;m}(k)=W_{DATA}a_{D;m}(k), respectively. However, the estimation process results in w_{DSCH;m}(k)=W_{C}a_{C;m}(k) (example 1) and w_{DATA;m}(k)=W_{c}a_{c;m}(k), (example 2), respectively. It should be mentioned that the channel coefficients a_{c;m}(k) and a_{DSCH;m}(k) as well as a_{C;m}(k) and a_{D;m}(k), respectively, are assumed to be identical, with the indices only expressing the fact that the channel coefficient results on the one hand from the processing of the P-CPICH channel, and on the other hand from the processing of the DSCH channel or of the pilots in the DCH channel. If one considers the equations (5a) and (6a) in example 1, as well as the equations (5b) and (6b) in example 2, respectively, then it is evident that the P-CPICH-specific gain W_{C}=W_{C,offset}W_{C,SF}, in each case differs from the DSCH-specific gain W_{DSCH}=W_{DSCH,offset}W_{PC}W_{DSCH,SF} and from the DPDCH-specific gain W_{DATA}=W_{DATA,offset}W_{PC}W_{D,SF} by the critical factor W_{PC}. In contrast to the other weight factors W_{C,offset}, W_{DSCH,offset, W}_{DATA,offset}, W_{DSCH,SF}, W_{C,SF}, this factor W_{PC} is critical since, as the power regulation weight factor, it varies from one time slot to the next, and thus over a code word. In the case of power regulation in the DSCH channel (example 1) and in the DCH channel, to be more precise in the data fields D, DATA, that is to say the DPDCH channel (example 2), this results in weight distortion in the combined data symbols. The ratio of W_{C} to W_{DSCH} and W_{DATA} may in this case vary within an order of magnitude of more than 10 dB within a code word in any case, as a result of the fading influences that are compensated for by the power regulation.

In order to improve the performance of the P-CPICH-based channel estimate, the estimation results obtained in step 1 are additionally normalized or corrected in step 2, thus overcoming the disadvantage that is inherent in step 1 that varying gain relationships between the P-CPICH channel on the one hand and the channels DSCH and DCH (DPDCH) on the other hand are ignored.

Step 2: step 2 takes account, in accordance with the present invention, of the varying gain relationships between the P-CPICH channel on the one hand and the DSCH channel or the DCH channel on the other hand.

The path weights w_{DSCH;m}(k) for example 1 and w_{DATA;m}(k) for example 2, as estimated in step 1, are all multiplied by the correction factor

$$f = \frac{{\hat{W}}_{DSCH}}{{\hat{W}}_{C}} \frac{1}{{\hat{σ}}_{DSCH}^{2}} \qquad ( 13 a )$$

for example 1, or the correction factor

$$f = \frac{{\hat{W}}_{Data}}{{\hat{W}}_{C}} \frac{1}{{\hat{σ}}_{D}^{2}} \qquad ( 13 b )$$

for example 2, respectively. The major component of this correction factor is the ratio of the gain estimate in the channel whose power is regulated to the gain estimate Ŵ_{C} based on the P-CPICH channel. This ratio compensates for the power regulation in the channel whose power is regulated. The estimated gain value for the channel DSCH is denoted Ŵ_{DSCH}, and the estimated gain value for the data-specific power regulation in the DPDCH channel is denoted Ŵ_{DATA}. In order to comply with the MRC principle, the correction factor optionally also includes the cell-specific noise variance on the channel whose power is regulated, in this case \hat{σ}_{DSCH}² for example 1, or \hat{σ}_{D}² for example 2.

The correction according to the invention of the path weights as estimated on the basis of the P-CPICH channel takes account of the influence of the power regulation and means that the RAKE receiver always emits data symbols with correct MRC weights over the entire length of a code word (which covers two or more data frames), so that these data symbols can be used for further data processing (in particular decoding).

The second product term (noise variances) also makes it possible to take account of noise power levels which vary over time in the correction factor f, based on equations (13a) and (13b).

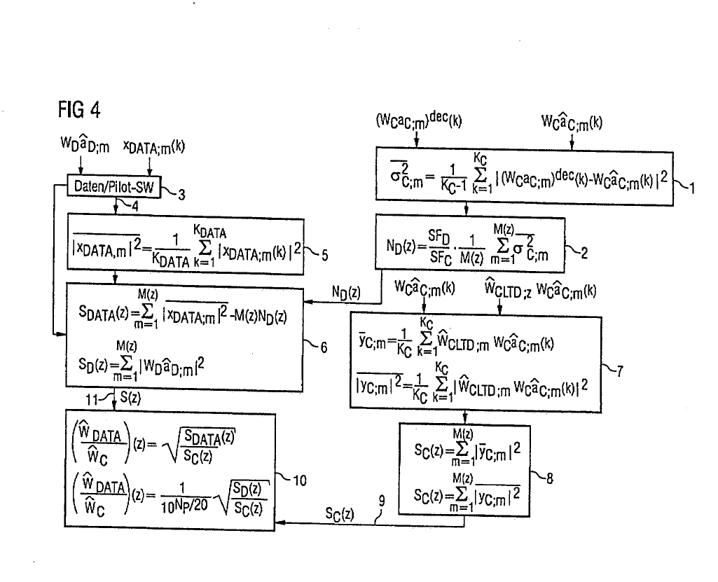

FIG. 4 shows various possible ways to calculate the correction factor f based on equation (13b), that is to say for example 2.

The noise estimation process in the blocks 1 and 2 is carried out on the basis of the formulae stated there, and the noise variance \hat{σ}_{D}² can be calculated on this basis. Path-specific noise variances are estimated on the basis of the P-CPICH channel in block 1. In this case, Kc denotes the number of common pilot symbols in the P-CPICH channel. Index m provides an index for the propagation paths and the allocated RAKE fingers m=1, . . . , M. z denotes a specific mobile radio cell. For clarity reasons, no multiple antenna diversity has been considered, so that summation processes over two or more transmission antennas have been suppressed in all of the equations in FIG. 4.

In block 2, the path-specific noise variances as calculated in block 1 are averaged over all of the M(z) propagation paths in the cell z under consideration, and are converted to the noise estimate N_{D}(z) for the power regulation taking into account the spreading factors SF_{C}=W_{C;SF} and SF_{D}=W_{D,SF}. Owing to the necessity for power regulation in UMTS mobile radio systems, the blocks 1 and 2 generally exist in mobile radio receivers in any case. The variable \hat{σ}_{D}² in equation (13b) can now be obtained directly from the output variable N_{D}(z) by multiplying it by the factor SF_{C}/SF_{D}.

The data symbols x_{DATA;m}(k) and the (channel-filtered) dedicated pilot symbols W_{D}â_{D;m} are passed to the block 3, which is in the form of a selection switch. The data symbols x_{DATA;m}(k) are supplied via a link 4 to a block 5 for carrying out path-specific signal averaging over the total number K_{Data} of data symbols in the DATA field.

The signal power S(z) for the mobile radio cell z is calculated in block 6. Calculation is either carried out on the basis of the data symbols in accordance with the above equation in block 6, that is to say S(z)=S_{DATA}(z), or the signal power is calculated on the basis of the pilot symbols in accordance with the lower equation in block 6, that is to say S(z)=S_{D}(z).

Furthermore, the power in the P-CPICH channel is calculated in blocks 7 and 8. The P-CPICH power value for the mobile radio cell z is denoted S_{C}(z). This is done by first of all carrying out a signal averaging process in block 7, based on one of the two equations shown in block 7. The above equation relates to averaging based on pilot symbols in the so-called “Normal Mode” or CLTD (Closed Loop Transmit Diversity), while the lower equation relates to averaging based on data symbols in the “Normal Mode” or CLTD. In a corresponding way, the upper equation in block 8 relates to the calculation of the P-CPICH power for power estimation based on pilot symbols, while the lower equation in block 8 relates to the calculation of the P-CPICH power for power estimation based on data symbols. In the case of power estimation based on pilot symbols, the averaging process is carried out first, followed by a squaring process, while the squaring process is carried out first, followed by the averaging process, for power estimation based on data symbols.

The respective power value S_{C}(z) in the P-CPICH channel is passed on via the data link 9 to a block 10 which, in addition, receives the signal power values S_{D}(z) and S_{DATA}(Z) of the calculated signal power, as calculated in block 6, via a link 11. The gain ratio Ŵ_{DATA}/Ŵ_{C}(z) as defined in equation (13b) is calculated for the cell z in the block 10. The upper equation in block 10 relates to the calculation of this ratio on the basis of data symbols, while the lower equation indicates this ratio being calculated on the basis of pilot symbols. In this case, Nₚ denotes the number of dedicated pilot symbols in the DPDCH channel.

The circuit illustrated in FIG. 4 can likewise be used for calculation of the noise variance \hat{σ}_{DSCH}² and of the estimated gain ratio Ŵ_{DSCH}/Ŵ_{C}(z) in example 1. In contrast to the functionality of the circuit described above, all of the variables are calculated purely on a data symbol basis. Block 3 is therefore omitted, and the symbols x_{DSCH,m}(k) are passed as input data to the block 5. The spreading factor SF_{DSCH} of the DSCH channel is used in block 2 instead of SF_{D}, so that N_{DSCH}(z) is calculated instead of N_{D}(z). The noise variance \hat{σ}_{DSCH}² that is required in equation (13a) is calculated analogously to example 2 on the basis of N_{DSCH}(z)SF_{c}/SF_{DSCH}. The ratio Ŵ_{DSCH}/Ŵ_{C}(z) is determined on the basis of the above equation in block 10, with the variable Ŵ_{DSCH} being used instead of Ŵ_{DATA}, and the variable S_{DSCH}(Z) being used instead of S_{DATA}(z), calculated analogously to the above equation in block 6. The P-CPICH power levels are calculated on the basis of data symbols, that is to say on the basis of the upper equations in blocks 7 and 8. In order to avoid storage of the DSCH data symbols throughout an entire time slot, the DSCH data symbols from the last time slot may be used to calculate the correction factor for the present time slot.

The two examples have the common feature that a powerful channel estimation process can be carried out on the basis of the P-CPICH channel by the use of the correction factor, and this channel estimation process overcomes the previously inherent disadvantage of a channel estimation process such as this—specifically that varying gain ratios in the payload channel (DSCH in example 1 or DPDCH in example 2) whose power is regulated are ignored.

All of the calculation steps illustrated in FIG. 4 as well as the calculation of the uncorrected path weights and the correction of the uncorrected path weights by the correction factor as calculated in block 10 can be carried out, for example, by a task-specific, hard-wired hardware circuit, or by a DSP (digital signal processor).

Although the invention has been illustrated and described with respect to one or more implementations, alterations and/or modifications may be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

1. A method for calculation of path weights for the equalization of a data signal that is transmitted via a data channel whose power is regulated in a RAKE receiver, comprising:
calculating at least one uncorrected path weight for the data signal that is transmitted via the data channel whose power is regulated, using channel estimation results that have been obtained on the basis of a common pilot channel (CPICH); and
correcting the at least one uncorrected path weight by multiplying it by a correction factor that contains a ratio of a data-channel-specific gain estimation to a pilot-channel-based gain estimation.

2. The method according to claim 1, wherein the data channel whose power is regulated comprises a common downlink channel DSCH based on the UMTS Standard.

3. The method according to claim 1, wherein the data channel whose power is regulated comprises a dedicated downlink channel DCH based on the UMTS Standard.

4. The method according to claim 1, wherein in calculating the at least one uncorrected path weight, two or more uncorrected path weights are calculated for two or more propagation parts of the data signal in a specific mobile radio cell, and in correcting the at least one uncorrected path weight, all of the uncorrected path weights for the mobile radio cell are multiplied by the same correction factor.

5. Method according to claim 1, wherein one of the the correction factor is
$$f = \frac{{\hat{W}}_{Data Channel}}{{\hat{W}}_{C}} \frac{1}{{\hat{σ}}_{D}^{2}} ,$$
where Ŵ_{Data Channel} is an estimated value for the transmitter gain for the data channel whose power is regulated, Ŵ_{C} is an estimated value for the transmitter gain for the common pilot channel and \hat{σ}_{D} an estimated value for a noise variance on the data channel whose power is regulated.

6. An apparatus for calculation of path weights for the equalization of a data signal which is transmitted via a data channel whose power is regulated in a RAKE receiver, comprising:
means for calculating at least one uncorrected path weight for the data signal that is transmitted via the data channel whose power is regulated, using channel estimation results obtained on the basis of a common pilot channel (CPICH);
means for calculating a correction factor, that contains the ratio of a data-channel-specific gain estimation to a pilot-channel-based gain estimation; and
means for correcting the at least one uncorrected path weight by multiplying it by the correction factor.

7. A method for calculation of path weights for the equalization of a data signal that is transmitted via a data channel whose power is regulated in a RAKE receiver, comprising:
calculating at least one uncorrected path weight for the data signal that is transmitted via the data channel whose power is regulated, using channel estimation results that have been obtained on the basis of a common pilot channel (CPICH); and
correcting the at least one uncorrected path weight using a correction factor that is a function of a power regulation in the data signal.

8. The method of claim 7, wherein the correction factor comprises a ratio of a data-channel-specific gain estimation to a pilot-channel-specific gain estimation.

9. The method of claim 8, wherein the correction factor further comprises an estimated value of the noise variance on the data channel.
